(19) United States
(12) Patent Application Publication
(10) Pub. No.: US 2016/0124435 A1
(43) Pub. Date: May 5, 2016

(54) 3D SCANNING AND IMAGING METHOD UTILIZING A SELF-ACTUATING COMPACT UNMANNED AERIAL DEVICE

(71) Applicant: Lyle Thompson, Thousand Oaks, CA (US)

(72) Inventor: Lyle Thompson, Thousand Oaks, CA (US)

(21) Appl. No.: 14/927,307

(22) Filed: Oct. 29, 2015

Related U.S. Application Data
(60) Provisional application No. 62/072,297, filed on Oct. 29, 2014.

(51) Int. Cl. G05D 1/08; G06F 17/50; H04N 7/18; G05D 13/62; B64C 39/02

(52) U.S. Cl. CPC G05D 1/0808; G05D 13/62; B64C 39/024; H04N 7/185; G06F 17/50; B64C 2201/141; B64C 2201/123

(57) ABSTRACT

New methods, systems and devices for the efficient activation of drone devices and scanning of objects for the processing of 3D image models are disclosed. These methods, systems and devices incorporate the use of unmanned aerial drones to scan and collect image data collectors, providing a convenient and efficient configuration for the scanning of objects, large immovable objects and living creatures. Further features according to the present disclosure include enhanced automation of the scanning process and easy activation of the scanning drone by initiating operation of the drone by a predetermined displacement of the drone.

### CROSS REFERENCE TO RELATED APPLICATIONS

This application claims the benefit of U.S. Provisional Application Ser. No. 62/072,297 to Lyle Thompson, et al., entitled 3D SCANNING AND IMAGING METHOD UTILIZING A COMPACT UNMANNED AERIAL DEVICE, filed on Oct. 29, 2014, which is hereby incorporated herein in its entirety by reference.

### BACKGROUND OF THE INVENTION

1. Field of the Invention

Described herein are methods, systems and devices regarding the enhanced activation and imaging features for utilization of a drone, for example, enhanced features enabling a drone to perform three-dimensional (3D) scanning, for example, for use in generating 3D image models for 3D printing systems, including drones comprising enhanced drone activation procedures.

2. Description of the Related Art

In recent years, 3D printing has arisen as an effective process for accurately developing 3D objects, such as for the purpose of prototyping and manufacture. In its most general sense, 3D printing typically utilizes a 3D scanner and/or computer software to generate an image map that is then translated in a grid-fashion, such that a device can deposit a material, such as a plastic, polymer or resin, via an additive process, creating a 3D object. Presently there are various 3D printing methodologies, each providing unique advantages and disadvantages. As 3D printing technology improves, implications for the 3D printing of even organic or semi-original materials, including food for human or animal consumption or organs and teeth for medical and dental transplants respectively, are becoming possible.

A 3D print typically begins by first generating a 3D image model utilizing software. This image model is typically generated utilizing a scanner, which operates in conjunction with a turntable platform or grid matrix platform combined with sensors attached to the object being scanned. These scanning configurations are typically bulky and are thus utilized in a controlled environment, such as a laboratory or scanning studio. A drawback of these conventional scanning technologies is that the large, bulky nature of the platforms utilized make scanning and imaging of large outdoor structures difficult. Furthermore, the scanning of moving or living objects is also cumbersome under the conventional methods of 3D scanning. Thus, if an individual is to be scanned and a 3D image generated, so that apparel could be 3D printed for that individual, or if it is desired to scan a mountain or famous landmark that is large and could not be transported, this procedure would be difficult.

An unrelated field of technology to 3D imaging that has also been undergoing rapid advances in technology is the field of aerial unmanned drones. These drones are being utilized to capture pictures and video from a variety of angles in the air. These drones are also being made increasingly smaller and more portable. At least one recently developed drone can be worn about the wrist in a manner similar to a wristwatch. However, these portable unmanned drones are not adequately configured for the 3D scanning purposes. Furthermore, these drones require inconvenient activation procedures, typically involving use of a control device rather than quick, convenient and efficient activation.

### SUMMARY

Embodiments incorporating features of the present invention provide effective methods, systems and devices utilizing unmanned aerial drones to improve the efficiency and convenience of drone use, for example, by providing enhanced activation features, as well as scanning capabilities for 3D imaging purposes. In some embodiments, drones incorporating features of the present invention include activation procedures that allow the drone to sense when the drone is displaced in space by a certain value in order to trigger activation, for example, being “tossed” into the air. These drones can sense a variety of operational variables, for example, acceleration, velocity and/or spatial displacement that can be compared to a threshold value to register that the drone was indeed displaced by a sufficient level to trigger activation of the drone.

In embodiments comprising features for 3D imaging, advantages of utilizing unmanned aerial drones as 3D scanning devices include being able to conveniently and efficiently scan large immovable objects, such as landmarks and to scan human subjects without causing discomfort. Embodiments according to the present disclosure further provide for a variety of convenient features to improve the usability of the unmanned aerial drone scanners, including features providing convenient automation and activation.

In one embodiment, a method of activating an unmanned aerial drone comprises the steps of changing a vertical and/or horizontal position of an unmanned aerial drone, measuring one or more operation dependent variables affecting the unmanned aerial drone, comparing the one or more operation dependent variables to a threshold value of one or more operation dependent variables and said drone becoming activated in response to said one or more values meeting said threshold value.

In another embodiment, a method of activating an unmanned aerial drone comprising the steps of changing the spatial position of the unmanned aerial drone from a starting position, measuring one or more operation dependent variables corresponding to said change in spatial position of said unmanned aerial drone, comparing the one or more operation dependent variables to a threshold value of one or more operation dependent variables, said threshold value corresponding to said starting position said drone becomes activated in response to said one or more values meeting said threshold value and the drone becoming activated in response to the one or more values meeting said threshold value.

In yet another embodiment, a method of activating an unmanned aerial drone and generating a three-dimensional (3D) image model comprises the steps of automatically activating the drone in response to a change of said drone's position, capturing image data utilizing an unmanned aerial drone, with the unmanned aerial drone configured to capture said image data, such that said image data can be utilized in the generation of a 3D image model and processing the image data into a 3D image model.

These and other further features and advantages of the invention are apparent to those skilled in the art from the following detailed description, taken together with the accompanying drawings, wherein like numerals designate corresponding parts in the figures, in which:

### BRIEF DESCRIPTION OF THE DRAWINGS

FIG. 1 shows a flow diagram representing a method of scanning and generating a 3D image utilizing an unmanned aerial scanning drone, which incorporates features of the present invention;

FIG. 2 shows a flow diagram representing a method of activating the unmanned aerial scanning drone incorporating features of the present invention;

FIGS. 3A-3C show graphical representations of the method 200 of FIG. 2, wherein:

FIG. 3A shows a graph of acceleration over time;

FIG. 3B shows a graph of velocity over time; and

FIG. 3C shows a graph of vertical displacement over time, which represents the integration of the velocity values of FIG. 3B, with optional additional corrections.

### DETAILED DESCRIPTION

Embodiments incorporating features of the present invention provide enhanced activation features for unmanned aerial devices, such as drones, as well as methods for the utilization of an unmanned aerial devices for capturing image data and for scanning of objects for the generation of 3D imaging models. These 3D image models can then be utilized in a variety of ways, including producing 3D printable structures. As the drones are compact and conveniently transportable and can freely fly unhindered about objects to be scanned, larger, unmovable objects, such as landmarks, can be effectively 3D imaged. Furthermore, as the drones are not confined by the dimensions of a platform, living creatures, such as human beings, can be 3D imaged without being uncomfortable due to being confined within a small space or having imaging sensors attached to them.

Another advantage of methods, systems and devices incorporating features of the present invention is that the drones can be outfitted with various features that are configured to improve user convenience, device automation and device usability. For example, conventional drones utilized for non-3D imaging purposes typically require constant users control and monitoring during operation and must be turned-on or activated from a stable initial starting position. Drones incorporating features of the present inventions, however, can be configured such that they record or track an object's position and perform the 3D scanning automatically. Furthermore, the devices can be activated and can turn on in response to various stimuli, for example, change in position, change in altitude, acceleration or velocity. This configuration allows a drone, that can be conveniently carried, for example, worn, carried in a pocket or attached to an article of clothing, to activate and initiate a 3D scanning procedure simply by being “tossed” up in the air with minimal user input.

Methods, systems and devices incorporating features of the present invention include various image capture configurations. For example, drones incorporating features of the present invention can include a single camera that uses the drone's flight path to provide viewpoints. In other embodiments, drones are configured with multiple cameras arranged, such that multiple viewpoints can be simultaneously processed. For example, one camera can be configured to be orientated generally horizontal to capture imaging of an object head-on, while another camera is configured to be orientated generally vertical and downward pointing to capture imaging of the object when positioned overhead. In some embodiments, one of more of the cameras can be outfitted with a moveable or adjustable mount surface. This allows a camera configured with the drone to capture imaging data without requiring that the entire drone orient itself in a particular position. This moveable or adjustable mount surface embodiment can also be configured to reduce the effect of drone movement on a camera, providing improved image stability. Any adjustable mounting platform arrangement known in the art for use with drone-based cameras can be utilized, for example, a gimbal platform.

In some embodiments, image capture can be achieved via multiple cameras in a fixed arrangement. According to these embodiments, each camera viewpoint provides triangulation from various positions with reference to the object to be scanned to further increase accuracy. In some embodiments, one or more 3D depth detection devices can be configured with each camera viewpoint and can provide additional data, and/or increase accuracy and thus reduce post-processing time of captured images.

In some embodiments, drones according to the present disclosure can comprise one or more lighting sources, for example, any sufficient lighting sources that are known in the art of scanning, including but not limited to various electrically powered lights, for example, LED-based lights, incandescent and fluorescent lights. An advantage with utilizing a drone comprising a light source is that good lighting can improve the quality of a scan. Such drone-mounted/integrated light sources can further comprise various angular arrangements, reflectors, or can be mounted to a moveable surface, for example, a gimbal, in order to adjust the lighting angle. The lighting sources can be fixed in place, configured to be co-positioned with a camera, such as those mentioned herein, and can move with the camera, or can be configured to move independently from the camera.

Methods, systems and devices incorporating features of the present invention include various configurations for locating and targeting an object to be scanned. In some embodiments, the starting location (e.g. the location from which the drone takes off from) is used as the target. One convenient advantage of this is that the steps required from a user are reduced, for example, a user can initiate the flight of the drone, and thus the scanning process, and the drone can automatically scan the user and/or the user's location and or remote locations. In other embodiments, an image can be targeted for scanning by the drone utilizing 3D coordinates or a global positioning system (GPS) to specify the target. In some embodiments, a signal-generating or other targeting device is placed on the object or in the general area to be scanned and a companion sensor on the drone detects the targeting-device. In some embodiments, a two-dimensional (2D) viewfinder is used to locate and identify the object to be scanned, for example, utilizing a view screen or remote communication to a device with such a viewfinder. In a further embodiment, the drone can be programmed to analyze the scan results, determine if areas were not adequately scanned and then rescan those portions of the object detected as inadequately scanned, so as to provide an improved scan image; this determination of inadequate scanning and subsequent re-scanning can be done automatically, or a user can be informed of the inadequate scan detected and can make the decision to re-scan or accept the inadequate scan.

The flight-path and movement-based operation of drones incorporating features of the present invention can be controlled in a variety of ways. In some embodiments, the 3D scanner drone navigates from the starting point to a pre-determined point a given distance from the subject. In some embodiments, the drone executes a flight-path rotating about the object to be scanned with at least one camera pointed at the object at specific points desired for image to be captured for the purposes of constructing a 3D image model. In some embodiments, the drone can also be remotely controlled by the user.

After an image has been scanned utilizing methods, systems and devices incorporating features of the present invention, various configurations to end the scanning process can be utilized. In some embodiments, after completing the scan, the drone will fly to a pre-designated location and slowly descend until contact with a lower surface, such as a landing surface, the ground, or a user's hand, has been detected. In some embodiments, the 3D imaging drone will fly to and land on a pre-designated landing platform. Such platform can be wearable, for example, built into or attached to something a person is wearing. In some embodiments, when an automated scanning procedure is completed, the drone will hover in place and give control to a remote operating device for manual control by a user or resume another pre-programmed automated procedure, for example, to return and land in a given location.

In some embodiments, an abort notification feature may also be included that can interrupt a scan and perform one of the termination actions described above. This abort notification can be initiated if the current scanning procedure may result in injury, property damage and/or damage to the drone, for example, if the drone is in danger of colliding with an object, is low on a resource such as power or fuel, or has lost control from an operating procedure or from a remote control. The notification may be sent via any signal means known in the art, including but not limited to electronic, audio, wireless or tactile means. Upon receiving an abort notification, the scan can be aborted and emergency landing initiated.

Example sensors that can be utilized in conjunction with an abort notification procedure include any sensor that can detect the presence or impending happening of a dangerous and/or undesirable condition, for example, touch/proximity (collision), heat (overheating), power/fuel (low operating energy), and light sensors (for example, if it is early evening and darkness will make scanning or location of the drone difficult). If, for example, a low light condition or excessive shadowing is detected, a drone-mounted light source, such as one or more LEDs, can be activated.

Throughout this description, the preferred embodiments and examples illustrated should be considered as exemplars, rather than as limitations on the present invention. As used herein, the term “invention,” “device,” “method,” “present invention,” “present device” or “present method” refers to any one of the embodiments of the invention described herein, and any equivalents. Furthermore, reference to various feature(s) of the “invention,” “device,” “method,” “present invention,” “present device” or “present method” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. It is also understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “outer”, “above”, “lower”, “below”, “horizontal,” “vertical” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

It is understood that when the present disclosure references a “drone,” unless otherwise indicated, the “drone” can refer to any unmanned aerial vehicle. Such “drones” can include any drone design that is known in the art and that can be configured with features of the present disclosure. In some preferred embodiments, the basic make and model of the 3D imaging drone is that of a quadcopter, a rotary helicopter-like drone comprising at least four rotary blades, such as those known in the art. Such quadcopters can be configured with the various novel elements set forth in the present disclosure to be configured for use with 3D scanning and to allow for improved and more convened usability. Some examples of conventional drone designs include those set forth in U.S. Pat. No. 8,695,919 to Shachor, et al., filed on Nov. 10, 2011, and U.S. Pat. No. 8,322,648 to Kroetsch, et al., filed on May 14, 2009, both of which are hereby incorporated into the present disclosure in their entirety by reference.

It is understood that when the present disclosure references a drone comprising a “camera,” unless otherwise noted, it is referring to any image capture device. For example, any device capable of capturing video or photographs, as well as devices that are specifically configured to performing a scanning function in order to generate a 3D image model or an image that can be later assembled into or utilized to generate a 3D image model. The camera can be configured to transmit images to storage media carried by the drone (for example computer memory such as Random Access Memory (RAM), Read Only Memory (ROM), an internal hard drive, or any known memory storage medium) or a remote storage and/or processing medium (which can be mobile or fixed in location) located a distance from the drone, for example, the drone can transmit data to a controller or smart phone, which can in turn, transmit the data to an information cloud or server. Still further, if a remote storage and/or processing location is used, two-way communication can also be provided.

It is understood that when the present disclosure references a drone “rotating” about an object, it is referring to the drone achieving a flight path of a variety of angles necessary to achieve a given scan and does not necessarily require that the drone completely rotate about the object.

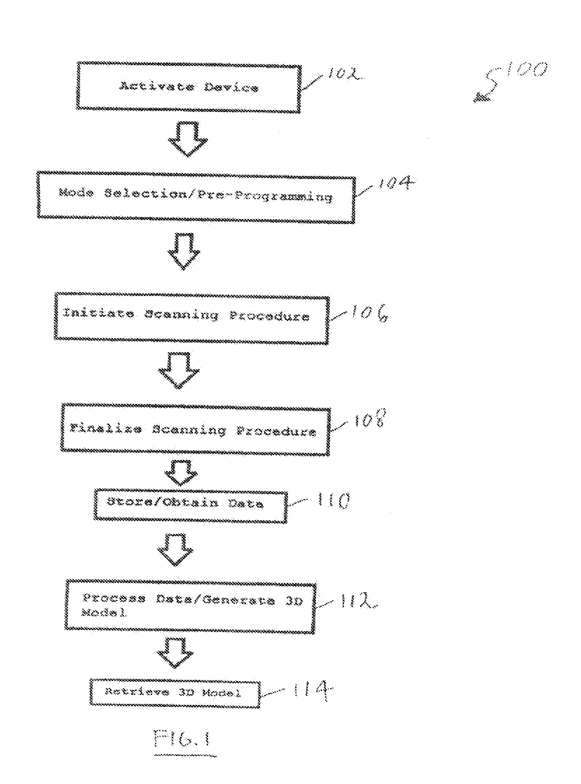

FIG. 1 shows an example method of generating a 3D image model 100 incorporating features of the present invention. In a device activation step 102, the scanning device is activated. According to the present disclosure, scanning devices utilized are unmanned aerial vehicles, such as drones. There are many drones in use today and drones themselves are readily known in the art for the use of capturing photographs and video. Any drone known in the art and capable of flight and image capture can be adapted in accordance with configurations incorporating features of the present invention. Rather than basic video and photo image capture, drones incorporating features of the present invention configured can be configured to capture image data, such that the image data can be more efficiently utilized in the generation of a 3D image model. For example, the drone can be configured to capture images of a given object in such a way that a 3D model can be easily generated from the recorded data, for example, by building a coordinated image map.

Many different camera configurations can be utilized with scanning drone devices incorporating features of the present invention. For example, a single-camera arrangement can be utilized. Rather than conventional 3D scanning, which typically uses a fixed camera and a rotatable platform upon which an object sits, or in the alternative, a stationary object confined to a given space while a fixed camera on a platform surrounding the stationary object is rotated about the object, the single-camera embodiment involves the aerial drone flying and rotating about an object that is thus not as confined as in the prior art embodiments. This is useful in the scanning of living and/or moving subjects as the discomfort of being confined to a small area while the scan takes place is undesirable. To further enhance accuracy, the camera can be fixed to various support structures known in the art to stabilize the camera and mitigate shaking caused by movement of the drone. Various image capture programs can also be used to accommodate for movements by the subject in the case of living subjects.

Multi-camera embodiments are another camera configuration incorporating features of the present invention. Utilizing this embodiment, different cameras on the drone can be configured to capture image data at different points on an object. Further processing, for example, via a program, can be utilized to use the different discrete points to build an image map. In some embodiments, these camera viewpoints are “fixed” and can provide triangulation data from desired positions on the scanning drone in relation to the object being scanned for increased accuracy. In other embodiments, the multiple cameras can be configured to each scan the whole object, but from different angles and/or views. This generates a larger set of image data, which provides more data in the processing of a 3D image model.

Any of the above camera configurations can be configured with one or more 3D depth detection devices for each viewpoint to provide additional data and/or increase accuracy. Furthermore, any of the above camera embodiments can be utilized with a single drone or multiple drones, for example, multiple drones specifically configured to work together in image gathering or generation or multiple drones working independently retrieving image data that can later be complied together to form an image model. An advantage of this is that collected data can be enhanced and further processed at the initial collection stage so that additional data manipulation during the generation of a 3D model based at a later processing step can be reduced, eliminated or mitigated.

The drone device and its various features can be activated during the activation step 102 in a variety of ways, for example, via an on/off switch/button or by connecting or disconnecting the drone from a tethered power supply or battery. Further configurations for activating the device include placing the device in a “passive mode,” wherein the device behaves as if it were powered off, but the device activates in response to a sound, a command, being dropped or tossed into the air, or experiencing a change in a threshold value corresponding to: velocity, acceleration or altitude. In some embodiments, the event is registered as a “toss event” if the threshold is met and/or if the value is less than the threshold, in other embodiments, the event is registered as a toss if the threshold is met and/or the value exceeds the threshold or toss event. Contrary to the standard definition of “toss” as meaning throwing, “toss” as used herein is meant to cover any movement of the drone sufficient to trigger an activating event (e.g. step 102) as described herein. As will be discussed in more detail below, the device can be powered on by being dropped or tossed into the air, or an actual scanning procedure can be initiated by the step of dropping or tossing the device into the air.

After the activation step 102, a user then executes a mode selection/pre-programming step 104. This step can involve selection of pre-programmed modes and/or user generated programmable commands; for ease of readability, however, this step will simply be referred to as the mode selection step 104. The mode selection step 104 need not be performed every time the method 100 is used, as the drone device can record the preferences from earlier programming of a user's preferred mode of operation, such that the user can simply skip from activating the device to the scanning initiation step 106. Furthermore, in some embodiments, the mode selection step 104 will not exist, as the device will be pre-programmed for only a single mode of operation. Accordingly, any of the modes disclosed herein can optionally be the default configuration of the drone scanning device. This can be advantageous in that such devices could be manufactured for less cost or made simple for less tech-savvy users. However, in preferable embodiments, a mode selection step 104 will exist to give a user more options regarding the use of the drone scanner.

Useful pre-generated modes for user selection in the mode selection step 104 include modes of device operation specifically configured for a particular object the user would like to scan. Various modes can be selected in which the scanning drone device is particularly configured to capture various objects, for example, large expanses of natural scenery, a large object such as a monument, a person (such as an individual scanning himself or herself), or a particular object or group of objects. For example, in an individual user scanning “selfie mode,” the device can be configured to execute a scanning procedure wherein a rotational radius and/or x-y-z axis coordinates for the device is set by the user. For example, a user can set a radius of 6 feet from the starting or launch point of the drone when the scanning procedure is executed, the drone will then position itself and rotate according to the set radius, scanning objects on one or both sides of the rotational path as desired. In some embodiments, the device is configured to detect a certain object, for example the user, and rotate about the object a distance utilizing the pre-programmed radius.

Various other present modes or adjustable features can be utilized in the mode selection step 104. For example, the user can select a “scenario mode” and instead of programming or selecting a pre-determined radius, the user can program or select a parallax distance encompassing the landmarks the user would like to scan. In a “viewfinder mode,” the user can first “tag” a particular target, allowing the drone device to triangulate the target's location and rotate about the target capturing image data.

As the scanning drone devices can be compact and relatively unobtrusive, it is possible to more efficiently and closely image individual objects or small groups of objects by allowing the drone to closely rotate about them. This is an advantage the compact drone embodiments have over larger drone embodiments. Drones incorporating features of the present invention can be made to be compact to varying degrees. It is preferable that the drones are small enough to accurately scan a given object, for example, by getting close enough to rotate about the object to achieve improved image data, without causing damage or injury. Drones can be made even more compact for user convenience, for example, being small enough to fit in a user's pocket or being able to be worn or attached to an article of a user's clothing.

Additional operational perimeters can be adjusted in the mode selection step 104. Various movement and imaging options can be adjusted, for example, to control an automated flight path and scanning procedure, including, but not limited to: radius or diameter of flight travel, maximum or minimum height of flight travel, various image resolution parameters (for example, how many images or passes the device collects), lens focal length, shutter speed, F-number (the ratio of the lens's focal length to the diameter of the entrance pupil), image storage means (for example, direct scan transferred to computer interface, attached external hard drive, internal hard drive, etc.), online or connected account information for image transfer, color depth, video filters/distortions, 3D filters/distortions, and any parameters known in the art for use with drone movement or imaging techniques.

After the mode of operation of the scanning drone has been determined, the scanning procedure can be initiated in the scanning procedure initiation step 106. The scanning drone device can be configured to be directly controlled by the user, for example, via a remote control device, for example, radio-controlled, Bluetooth®, or other wireless configuration. A user can use the remote control to direct and control the device during flight. The remote control can have a screen that allows the user to see what the drone is viewing and can direct the drone about an object the user wants to scan. A program in the remote control or drone itself can help direct the user's control of the device, such that an adequate scan is achieved. In some embodiments, the user initiates and manually controls the scanning process all through a remote control device.

In some embodiments, as has been previously mentioned, the device is automated and will perform the scanning procedure automatically with little to no user input. A user will initiate the scanning procedure in the initiate scanning procedure step 106 by performing an action, speaking a command or activating a button, switch or sensor on the drone device itself. The drone will then perform the scanning procedure it is programmed for, including integrating parameters programmed from the mode selection step 104. As previously mentioned, the drone could begin flight and subsequent image collection in accordance to a predetermined flight path due to a set radius, x-y-z axis input, or GPS coordinates. In other embodiments, an object can be “tagged” via a triangulating sensor on the device, a remote sensor attached to the object, a laser targeting device or by inputting the GPS coordinates of the object, with the drone configured to fly around and collect image data regarding the tagged object.

One configuration incorporating features of the present invention, which can be utilized to initiate the scanning procedure in the scanning procedure initiation step 106 is the “toss” procedure, set forth herein. According to embodiments incorporating the “toss” procedure, an activation act by an appropriate action, such as a simple toss of the drone into the air or dropping of the drone, can begin the device activation step 102 and/or begin the scanning procedure initiation step 106. This improves user convenience as, for example, a compact drone can simply be easily removed from a user's person and tossed into the air, initiating an automatic scanning procedure, reducing time, adjusting the scanning drone, utilizing remote devices, etc.

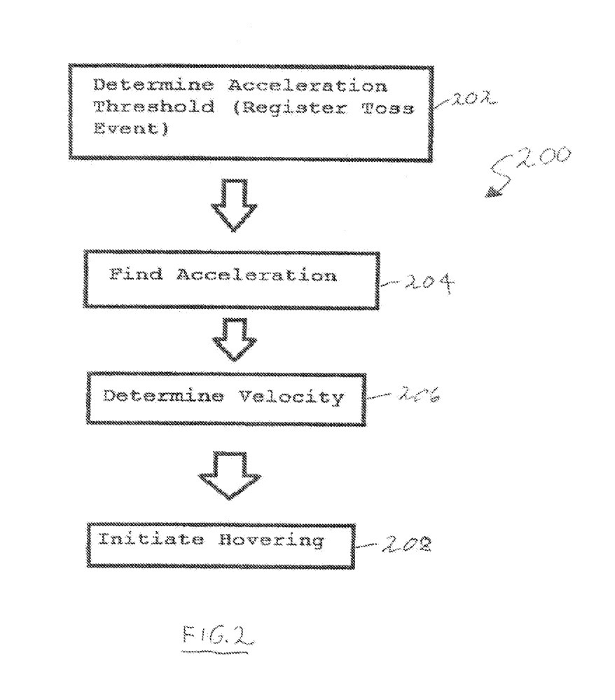

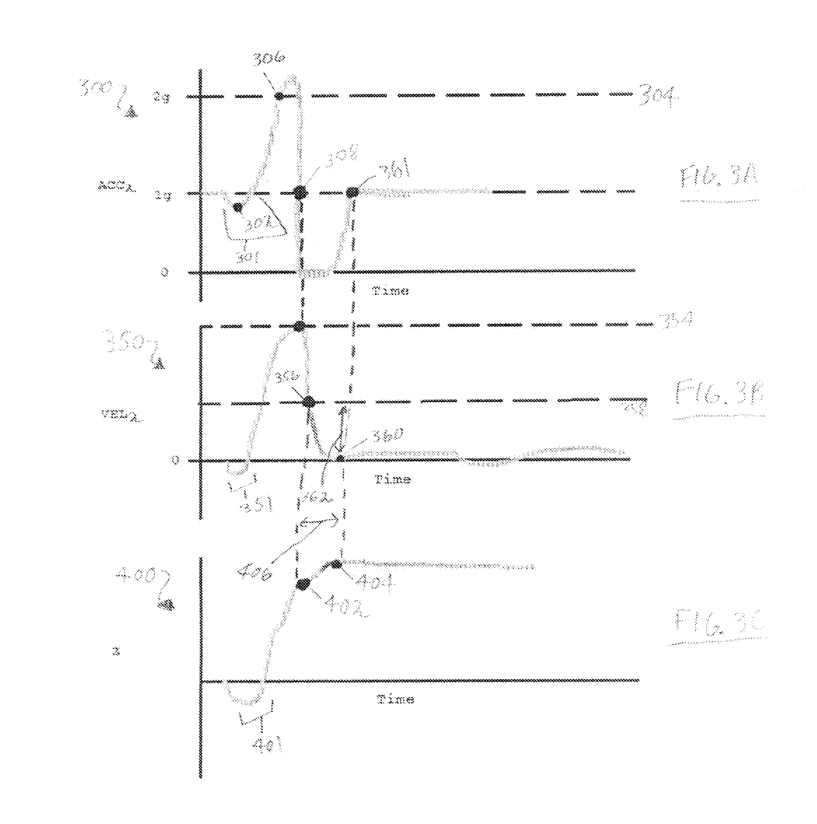

The presence of a toss event, which initiates the toss procedure can be detected and measured in a variety of ways. For example, a touch or proximity sensor on the underside of the device can detect when the device has been positioned on a surface, for example, a user's hand, and has lost contact with that surface (indicating a toss event). In some embodiments, an accelerometer (with or without an accompanying gyroscope) to detect a minimum acceleration level is utilized. In some embodiments, altitude sensors are utilized and once a drone has reached a certain altitude from a predetermined starting point the procedure can activate. In some embodiments, velocity is calculated and used to determine the presence of a toss event. These embodiments are discussed further with reference to FIGS. 2-3C below. It is contemplated, as previous defined, that the term “toss” includes any action where the drone is released from an initial “start” location. It is also contemplated that the term “toss” can include a simple change in spatial position, for example vertical and/or horizontal displacement, in lieu of or in addition to a throw or drop.

After the drone has captured image data and completed the scanning procedure, a scanning procedure finalization step 108 is performed. This step can be manually initiated by the user, for example, via a remote control device and/or can be automated. In some embodiments, the drone can fly to a designated location and slowly descend until proximity to or contact with a lower surface has been detected, for example, if the device was caught by a user or makes contact with a landing surface.

In some embodiments, the drone can fly to and land on a designated landing surface, which can either be a designated surface pre-programmed into the drone, for example, utilizing GPS coordinates, or could be the initial position the drone was in when the device activation step 102 or the scanning procedure initiation step 106 were initiated. In other embodiments, the designated landing surface can be designated with a beacon or can be an optimized target surface. In embodiments, wherein the scanning procedure was automated or semi-automated, the drone can be programmed to hover in place upon reaching the scanning procedure finalization step, and manual control can be returned to the user or another remote operator.

In some embodiments, the scanning procedure finalization step 108 can be initiated prior to completion of a scanning procedure, for example, by a user sending a signal to abort the process or an automated abort notification being received by the scanning drone device. Such an abort notification can be received, as mentioned above, if a collision or device malfunction is imminent. This can be detected through various sensors including, for example, touch/proximity, heat, power/fuel, and light sensors.

After the scanning procedure has been finalized or simultaneously occurring in conjunction with the scanning procedure, the data-obtaining step 110 is then performed. In this step, data is confirmed and stored and/or transferred to another medium. The confirmation portion of the data-obtaining step 110 can be automated and/or user driven. In the automated embodiments, image data captured during a scanning procedure can be automatically accepted and thus stored and/or transferred or a computer program can analyze the image utilizing set perimeters to determine clarity, integrity and/or suitability for use in later 3D model processing. In embodiments where the scanned data is confirmed by the user, the user can look at a computer interface, for example, on a laptop, smartphone or electronic tablet device, to which the data can be viewed or transferred to. In some embodiments, the drone itself, or a remote control device utilized with the drone, can comprise a viewable screen and/or interface that the user can use to view a set of collected image data and reject or deny it through interaction with the device and/or interface.

After the image data has been confirmed, it can be stored and/or transferred to another device. Storage of either the raw image data, post-processed image data (e.g. compressed), or the resulting final 3D model can be accomplished on the device, or on an accessory such as a remote control device configured with the drone or on a smartphone with an appropriate program installed. Data can also be stored on an external and removable medium, for example, a Universal Serial Bus (USB) drive or a data card. Data can also be transferred via the internet to/and from servers. In some embodiments, the user can set up and account on a server to manage stored image data. In some embodiments, the data can be transferred wirelessly to another device within wireless range via Bluetooth® or other wireless technology.

After data has been stored on the scanning drone device or has been transferred to another medium in the data-obtaining step 110, the data can be further processed, if the user desires (either via user input request or programmed to occur automatically), into a fully enabled 3D image model in an image model processing step 112. As an initial matter, it will be useful to discuss where the image processing events can take place. In some embodiments, processing can occur locally on the scanning drone device itself. In some embodiments, processing can occur remotely on an accessory configured with the device, for example, a smartphone, laptop, electronic tablet, or a remote control; the device can connect to the accessory via a wired or wireless connection. In some embodiments, processing can occur on a remote device to which the data has been transferred utilizing any transfer configuration known in the art, including the transfer configurations discussed above with reference to the data-obtaining step 110. In some embodiments, processing can occur via an internet-based service.

The actual processing of the data into a 3D model can include any 3D model processing methods known in the art, as well as any methods according to the present disclosure. In some embodiments, processing of sensor data into a 3D model includes one or more of the following: rejection of images with problems or poor quality, selection of best images for processing, co-location of images in 3D space (which can be done relatively between images and/or via location data provided), association of color information with a 3D model, and combining of images in 3D space to provide a single 3D model.

After the image data collected during the scanning procedure has been processed into a 3D image model, the 3D image model can be utilized in a variety of ways, including but not limited to: showing the 3D image model on a viewfinder on the device, 3D printing of the 3D image model, holographic rendering of the 3D image model, a virtual reality environment rendering of the 3D image model and augmented reality display system rendering of the 3D image model. In some embodiments, the 3D image model is then retrieved in an image model retrieval step 114.

FIG. 2 shows an example method 200 of utilizing the “toss” procedure discussed above, which can be utilized to begin the device activation step 102 and/or the scanning procedure initiation step 106 shown in FIG. 1 above. In the method 200 shown in FIG. 2, velocity of the device is utilized as the primary feature to determine the toss event and thus turn on the device or initiate a scanning procedure or other automated function.

With continued reference to the method 200 of FIG. 2, in a threshold determination step 202, an acceleration threshold is determined and set as the threshold to register a toss of the scanning drone as a toss event. In some embodiments, the event is registered as a “toss event” if the threshold is met and/or if the value is less than the threshold, in other embodiments, the event is registered as a toss if the threshold is met and/or the value exceeds the threshold. In the embodiment of FIG. 2, the acceleration threshold is set to 2g. The acceleration of the scanning drone can be detected using any method of detecting acceleration, and optionally orientation, known, for example, an accelerometer with or without an accompanying gyroscope.

After it has been determined that the drone has achieved the acceleration threshold and a drop in acceleration is detected, the next step is to measure the acceleration of the scanning drone in an acceleration finding step 204. After acceleration is found and a baseline acceleration, for example in this embodiment, g (the factor of Earth's gravity) is subtracted, it is integrated to determine velocity in a velocity determination step 206. It is presumed that typically the baseline value will correspond to Earth's gravity as the device will usually start from a “rest” position on Earth, however, use of the device in other environments and conditions are contemplated and corresponding baselines can be subtracted accordingly prior to the integration of the acceleration. In a hovering initiating step 208, the velocity determined above is compared to a velocity threshold. The velocity threshold is determined by the change in acceleration after the acceleration threshold has been hit, plus the amount of time it takes to initiate hovering of, or otherwise activate, the scanning drone device. If the velocity determined in the velocity determining step 206 meets or is less than the velocity threshold, the hovering of the drone device is initiated. The device will then be activated and/or a scanning procedure will start according to the selected parameters discussed above.

FIGS. 3A-3C show graphical representations of the method 200 of FIG. 2 above. FIG. 3A shows a graph of vertical acceleration over time 300. FIG. 3B shows a graph of vertical velocity over time 350, which represented the subtraction of a baseline acceleration, in this case, Earth's gravity, followed by integration of the values in FIG. 3A. FIG. 3C shows a graph of vertical displacement over time 400, which represents the integration of the velocity values of FIG. 3B, with optional additional corrections. The graphs (3A-3C) show a wind-up element 302 to the “toss” where the user lowers the drone by a small amount as part of the tossing action. This is reflected by first, second, and third graphical variations 301, 351, 401 in the graphs in FIGS. 3A, 3B and 3C respectively. In this embodiment, the wind-up element is not used to detect the toss, but it might be measured and used to control other aspects of the “toss” or behavior after the toss. Referring now to FIG. 3A, the toss is initiated at a first point 302, which shows an increase in acceleration in the positive direction until the scanning drone reaches an acceleration threshold 304 at a first acceleration point 306. This can detected by a drone controller area and can register that a toss has occurred. At this point or soon thereafter, acceleration will reach its maximum and then drop precipitously as the drone leaves contact with the launching surface (e.g. hand), at which time it can be measured at a second acceleration point 308.

Referring now to FIG. 3B, a peak velocity 354, which corresponds to the second acceleration point 308 in the graph 300 in FIG. 3A above, is shown. A velocity threshold 358 can be computed from peak velocity 354. A second velocity point 356 corresponds to the initiation of hovering as it drops below the set velocity threshold 358. Hovering is actually achieved, due to factors, such as limitations of technology resulting in hovering not being instantaneously initiated, after the initiation, which occurs at the second velocity point 356, at a hovering point 360, which corresponds to a hovering point 361 in graph 300 in FIG. 3A.

FIG. 3C shows that the second velocity point 356 corresponds to a first vertical displacement point 402. As is shown in the graph 400 of FIG. 3C, vertical displacement still continues to occur from the initiation of hovering at the first vertical displacement point 402 until the time it takes for the hovering procedure to actually execute and begin hovering at a second vertical displacement point 404, which corresponds to hovering point 360 in the graph 350 of FIG. 3B and hovering point 361 in graph 300 in FIG. 3A. The time it takes between the initiation of the hovering protocol and for actual hovering to occur is shown in FIG. 3C as a second graphical distance 406 which corresponds to the change in velocity value of a first graphical distance 362 in FIG. 3B. When the time to achieve hovering, second graphical distance 406, is known, the threshold to commence hovering 356 can also be determined by estimating the time and manner by which the velocity curve will become 0 at point 360, for example, by various curve fitting techniques, and working backwards to compute the threshold velocity 356 corresponding to the ideal time for point 402, such that hovering occurs at or very near the natural peak of the toss.

The present disclosure is directed to the use of unmanned aerial drones in generating 3D image models as well as the toss protocols for activation of the drone in non-3D imaging embodiments. Accordingly, it is understood that the control and operational aspects of the invention are intended to cover both 3D imaging and non-3D imaging embodiments and the activation of the drone can occur without activating the 3D imaging procedures.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above.

The foregoing is intended to cover all modifications and alternative constructions falling within the spirit and scope of the invention as expressed in the appended claims, wherein no portion of the disclosure is intended, expressly or implicitly, to be dedicated to the public domain if not set forth in the claims.

I claim:

1. A method of activating an unmanned aerial drone comprising the steps of:
changing a vertical and/or horizontal position of said unmanned aerial drone;
measuring one or more operation dependent variables affecting said unmanned aerial drone;
comparing said one or more operation dependent variables to a threshold value of said one or more operation dependent variables; and
said drone becomes activated in response to said one or more values meeting said threshold value.

2. The method of claim 1, wherein said one or more variables comprise acceleration.

3. The method of claim 1, wherein said one or more variables comprise velocity.

4. The method of claim 1, wherein said one or more variables comprise spatial displacement.

5. The method of claim 4, wherein said spatial displacement is detected utilizing absolute or relative location.

6. The method of claim 1, wherein activating said drone is done automatically in response to said one or more variables.

7. The method of claim 1, wherein said measuring one or more variables affecting said drone comprises utilizing an accelerometer.

8. The method of claim 7, wherein said measuring one or more variables affecting said drone comprises further utilizing a gyroscope.

9. The method of claim 1, wherein said measuring one or more variables affecting said drone comprises using one or more switches, allowing for user input and control.

10. A method of activating an unmanned aerial drone comprising the steps of:
changing the spatial position of said unmanned aerial drone from a starting position;
measuring one or more operation dependent variables corresponding to said change in spatial position of said unmanned aerial drone;
comparing said one or more operation dependent variables to a threshold value of said one or more operation dependent variables, said threshold value corresponding to said starting position;
said drone becomes activated in response to said one or more values meeting said threshold value.

11. The method of claim 10, wherein said one or more values comprise acceleration.

12. The method of claim 10, wherein said one or more values comprise velocity.

13. The method of claim 10, wherein said measuring one or more values affecting said drone comprises utilizing an accelerometer.

14. The method of claim 10, wherein said measuring one or more values affecting said drone comprises further utilizing a gyroscope.

15. A method of activating an unmanned aerial drone and generating a three-dimensional (3D) image model comprising the steps of:
automatically activating said drone in response to a change in the position of said drone;
capturing image data utilizing an unmanned aerial drone, said unmanned aerial drone configured to capture said image data such that said image data can be utilized in the generation of a 3D image model; and
processing said image data into a 3D image model.

16. The method of claim 15, wherein said unmanned aerial drone is configured to fly utilizing automated controls and to detect an object.

17. The method of claim 15, wherein said unmanned aerial drone is configured to detect being tossed.

18. The method of claim 17, wherein said step of capturing image date is automatically initiated by said unmanned aerial drone being tossed.

19. The method of claim 17, wherein said unmanned aerial drone is configured to detect being tossed by measuring change in velocity.

20. The method of claim 15, further comprising the step of storing said image data in a storage medium.
